(19) United States
(12) Patent Application Publication
(10) Pub. No.: US 2016/0170675 A1
(43) Pub. Date: Jun. 16, 2016

(54) Superconducting Fiber and Efficient Cryogenic Cooling

(71) Applicant: SMART STORAGE SYSTEMS, INC., Milpitas, CA (US)

(72) Inventors: Gary R. Pickerell, Blacksburg, VA (US); Daniel S. Homa, Blacksburg, VA (US)

(21) Appl. No.: 14/909,341

(22) PCT Filed: Jul. 29, 2014
(86) PCT No.: PCT/US2014/049736

§ 371 Date: Feb. 1, 2016

Related U.S. Application Data
(60) Provisional application No. 61/859,907, filed on Jul. 30, 2013.

(51) Int. Cl. G06F 3/06

(52) U.S. Cl. CPC G06F 3/0629; G06F 3/0604; G06F 3/0616; G06F 3/0653; G06F 3/0688

(57) ABSTRACT

A fiber with a superconducting core and a glassy cladding with or without holes, voids or pores. The cladding voids, holes, pores and/or passageways may be used to carry a medium such as liquid helium to cool the superconducting material to its transition temperature. The cooling medium can be injected via a pressure drop between the open ends of the fiber, i.e. pressure or vacuum.

### CROSS-REFERENCE TO RELATED APPLICATIONS

This application claims the benefit U.S. Provisional Application Ser. No. 61/859,907, filed Jul. 30, 2013 and herein incorporated by reference.

### BACKGROUND OF THE INVENTION

The present invention is in the technical field of superconductor fibers, cables and wires, as well as fiber-optoelectronic devices, superconducting electronics, and optical fiber sensing. More particularly, the present invention is in the technical field of superconducting fibers for use in electrical transport.

Although superconductivity has been a focus of intense research since its discovery, the world has only gotten a glimpse of its potential to revolutionize the lives of its citizens. Superconductors have enabled Magnetic Resonance Imaging (MRI) and the superconducting quantum interference devices (SQUID). However, superconductors have yet to experience the revolution witnessed in semiconductor and optical fiber technologies.

The promise of superconductivity also continues to cultivate a sustained and intense interest because of the inverse relationship between finite sources of energy and the demands of a growing industrialized global community. Superconductivity is an inherent solution to the challenges of electric power transmission, transportation, and magnetic energy storage.

The trajectory of research and developments in the field of superconductivity appeared to change in 1987 upon the discovery of “high-temperature” superconductivity in yttrium barium copper oxide (YBCO) because of the higher transition temperatures, 93 K, that allowed the use of a much more cost effective cryogen: liquid nitrogen.

Although the pursuit of “room-temperature” superconductivity continues, significant effort has been dedicated to improved cable designs and manufacturing processes for these basic high-temperature superconductors. Although work over the past few decades has made superconductivity relevant in an increasing number of applications, superconductivity has yet to be widely adopted and utilized. The lack of traditional cable structures has, in part, impeded mass commercialization.

While recent improvements in cable designs and manufacturing progress has been made in the development of high quality, long length, high current coated high temperature superconductor cables have shown promise, these cables are often very exotic and require complicated manufacturing processes. Improvements in ancillary technologies such as cryogenic efficiency, cryostat reliability and deployment are also required for complete integration into power transmission and sensing applications. Simple and cost effective superconductive conductor designs and fabrication processes are required to enable wide implementation.

### BRIEF SUMMARY OF THE INVENTION

The present invention, in one embodiment, concerns a superconducting fiber with a superconducting core surrounded by cladding that may be made from fused silica. In another embodiment, the cladding further includes passageways for active cryogenic cooling. The holes, voids, pores and/or passageways may be random or ordered and create passageways for the flow of a cooling fluid. This permits an efficient approach to cooling the superconducting core with a cooling medium such as liquid nitrogen, helium and/or air.

The fluid may be a liquid, gas, gaseous vapor and combinations thereof. The cooling medium can be injected via a pressure drop between the open ends of the fiber, i.e. pressure or vacuum, and/or simple capillary action.

The superconducting fiber designs of the present invention are readily deployable with the current electrical power and optical fiber infrastructures, and may be deployed as or with optical fiber sensors and devices, and/or components of these. The superconducting fibers of the present invention allow for efficient cooling of the superconductor core with an extremely small footprint.

### BRIEF DESCRIPTION OF THE SEVERAL VIEWS OF THE DRAWINGS

FIG. 1 is a cross-sectional view showing a fiber with a superconducting lead core and fused silica cladding.

FIG. 2 is a cross-sectional view showing a superconducting fiber with a yttrium barium copper oxide core material and fused silica cladding.

FIG. 3 is a cross-sectional view showing a superconducting fiber with a bismuth strontium calcium copper oxide core material and fused silica cladding.

FIG. 4 shows an X-ray elemental map of the components (Pb, O, Si) of a superconducting fiber with a superconducting lead core and fused silica cladding.

FIG. 5 shows an X-ray elemental map of the components (Y, Ba, Cu, Si, O) of a superconducting fiber with a yttrium barium copper oxide core material and fused silica cladding.

FIG. 6 shows an X-ray elemental map of the components (Bi, Sr, Ca, Cu, Si, O) of a superconducting fiber with a bismuth strontium calcium copper oxide core material and fused silica cladding.

FIG. 7 shows the superconducting transition at the critical temperature of an embodiment of the invention having a lead core and fused silica cladding.

FIG. 8 is a cross-sectional view showing another embodiment of the invention wherein a superconducting fiber with a superconducting lead core has holes, pores, voids and/or passageways disposed in the fused silica cladding for cryogenic cooling.

FIG. 9 is a cross-sectional view showing another embodiment of the invention wherein a superconducting fiber with a yttrium barium copper oxide core has holes, pores, voids and/or passageways disposed in the fused silica cladding for cryogenic cooling.

FIG. 10 shows a system that may be used to cryogenically cool a superconducting fiber.

FIG. 11(a) shows the superconducting transition of a fiber with a superconducting lead core upon the injection of liquid helium into the holes, voids, pores and/or passageways disposed in the fused silica cladding.

FIG. 11(b) shows the subsequent transition from superconducting behavior.

FIG. 12 shows a fiber drawing system utilized to fabricate a fiber with a superconducting core.

FIG. 13(a) shows the electrical resistance as a function of temperature upon full immersion in liquid nitrogen for a commercial brass laminated high-temperature superconducting wire and one embodiment of the present invention having a YBCO core superconducting fiber with a fused silica cladding.

FIG. 13(b) shows the electrical resistance as a function of temperature upon full immersion in liquid nitrogen for a commercial bulk YBCO disk and one embodiment of the present invention having a YBCO core superconducting fiber with the fused silica cladding.

FIG. 14 is a cross-sectional view illustrating a further embodiment of the present invention.

### DETAILED DESCRIPTION OF THE INVENTION

This description is not to be taken in a limiting sense, but is made merely for the purpose of illustrating the general principles of the invention. The scope of the invention is defined by the appended claims.

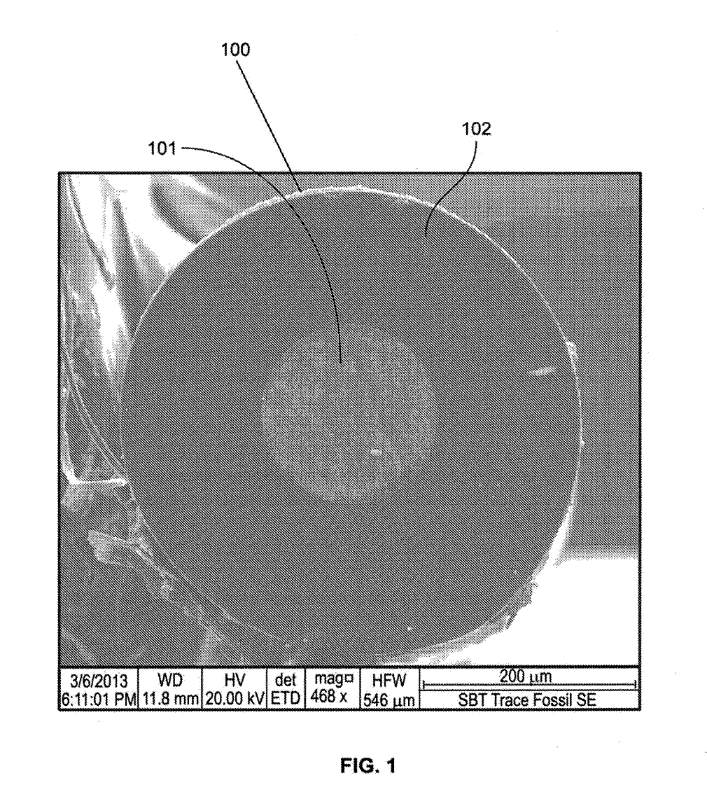

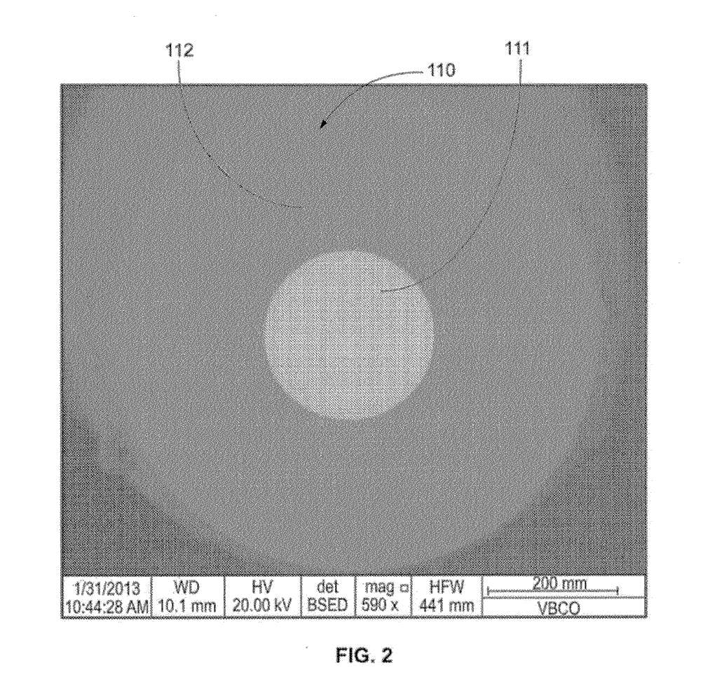

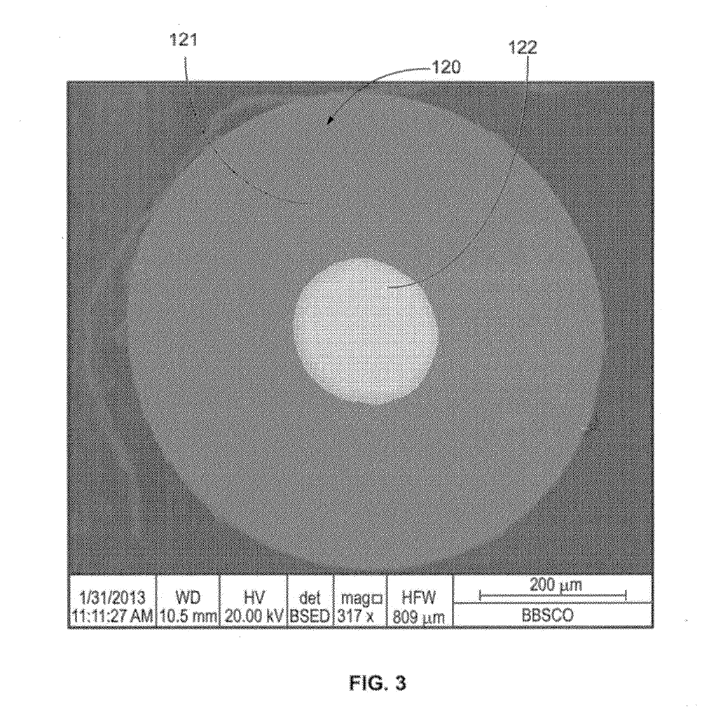

FIGS. 1 through 3 show fibers with a superconducting core material and fused silica cladding. Fiber 100 in FIG. 1 has a lead core 101 and fused silica cladding 101. Fiber 110 in FIG. 2 is a high-temperature Type II superconducting fiber having a yttrium barium copper oxide core 111 and fused silica cladding 112. It exhibits zero resistance at temperatures of approximately 93 K and may have an overall diameter ranging from 100-900 microns and core diameter ranging from 50-700 microns. Fiber 120 in FIG. 3 has a bismuth strontium calcium copper oxide 121 core and fused silica cladding 122.

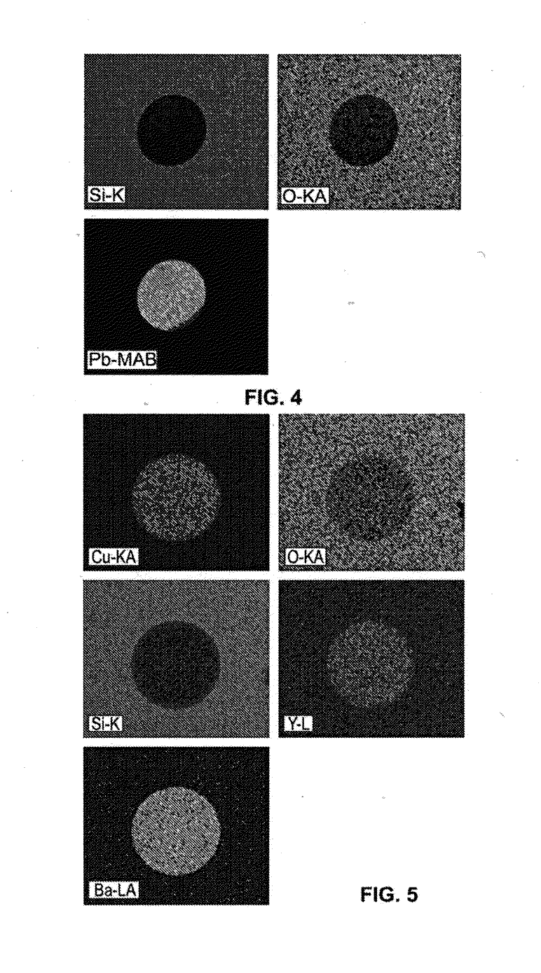

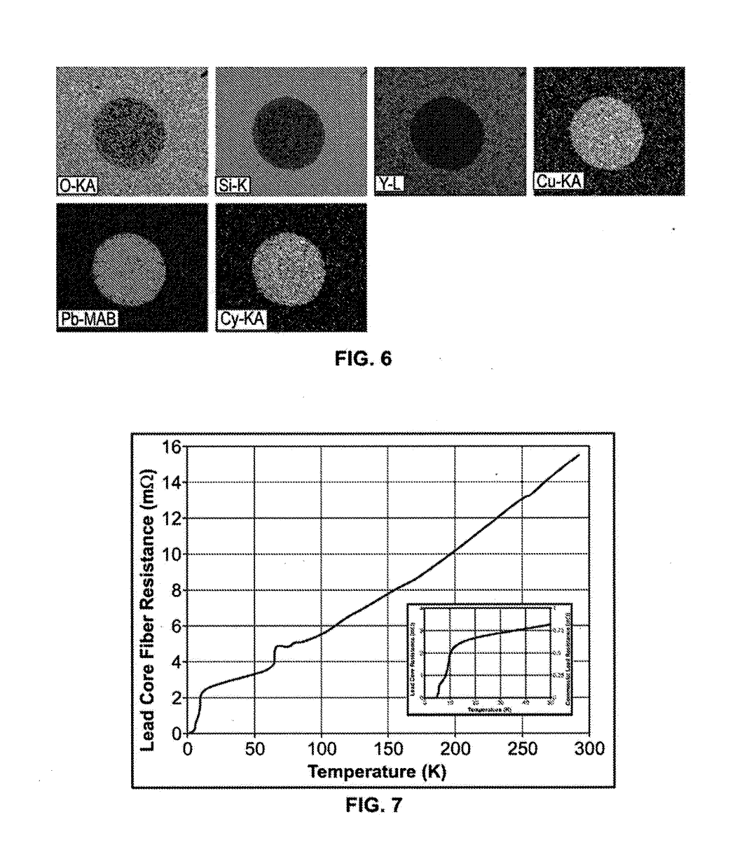

FIGS. 4 through 6 provide X-ray elemental dot maps for the fibers shown in FIGS. 1 through 3, respectively. As shown, the compositions of the superconducting fibers are stable with minimal cross-diffusion of the elements between the core and cladding regions.

The resistance versus temperature plot in FIG. 7 shows the transition to superconductivity at the critical temperature of approximately 7.2K for the lead core superconducting fiber. The plot demonstrates the basic performance of the embodiments of the invention.

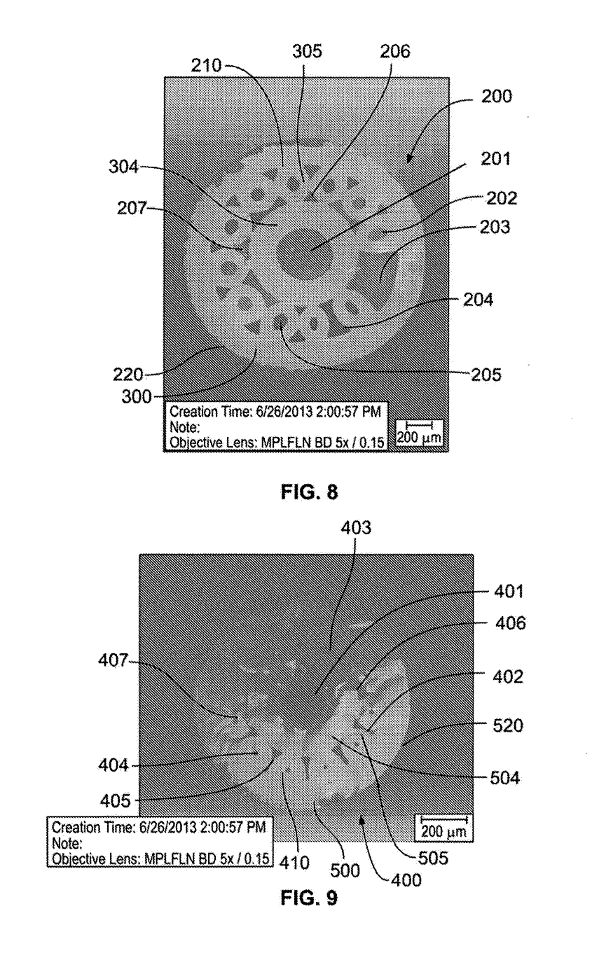

FIG. 8 illustrates another embodiment of the present invention. The 900 micron fiber 200 has an approximate 230 micron superconducting lead core 201 and voids, holes, pores and/or passageways 202 through 207 in cladding 210. The passageways may have varying cross-sectional configurations.

Cladding 210 may be a thermal insulating material surrounding core 201 such as fused silica or a multicomponent glass such as a borosilicate. The plurality of passageways 202 through 207 are arranged to permit the passage of a cooling fluid to cool core 201.

As also shown in FIG. 8, cladding 210 may have a first void-less region 300 and a second void-less region 304. A third region 305 is disposed between the void-less regions and contains the passageways in a spaced apart relationship away from core 201 and outer edge 220 of cladding 210.

In other embodiments, the present invention provides a superconducting fiber that has a superconducting core surrounded by a glass cladding that may act as an insulator. In other embodiments, the superconducting fiber has a superconducting core surrounded by one or more passageways for active cryogenic cooling. The holes, voids, pores and/or passageways may be random or ordered and create passageways for the flow of a cooling fluid. This permits an efficient approach to cooling the superconducting core with a cooling medium such as liquid nitrogen, helium and/or air. The passageways may also be located in a glass cladding which surrounds the passageways and core. The cladding itself may contain holes, pores or voids which contain air, nitrogen or other gasses. In this embodiment the cladding functions as an insulating layer.

FIG. 9 illustrates another embodiment of the present invention. The 900 micron fiber 400 has an approximate 230 micron superconducting yttrium barium copper oxide core 401 and voids, holes, pores and/or passageways 402 through 407 in cladding 410. The passageways may have varying cross-sectional configurations.

Cladding 410 may be a thermal insulating material surrounding the core such as fused silica. The plurality of voids 402 through 407 are arranged to permit the passage of a cooling fluid to cool core 401.

As also shown in FIG. 9, cladding 410 may have a first void-less region 500 and a second void-less region 504. A third region 505 is disposed between the void-less regions and contains the passageways in a spaced apart relationship away from core 401 and outer edge 520 of cladding 510. The cladding itself may also contain holes, pores or voids which contain air, nitrogen or other gasses. In this embodiment the cladding functions as an insulating layer.

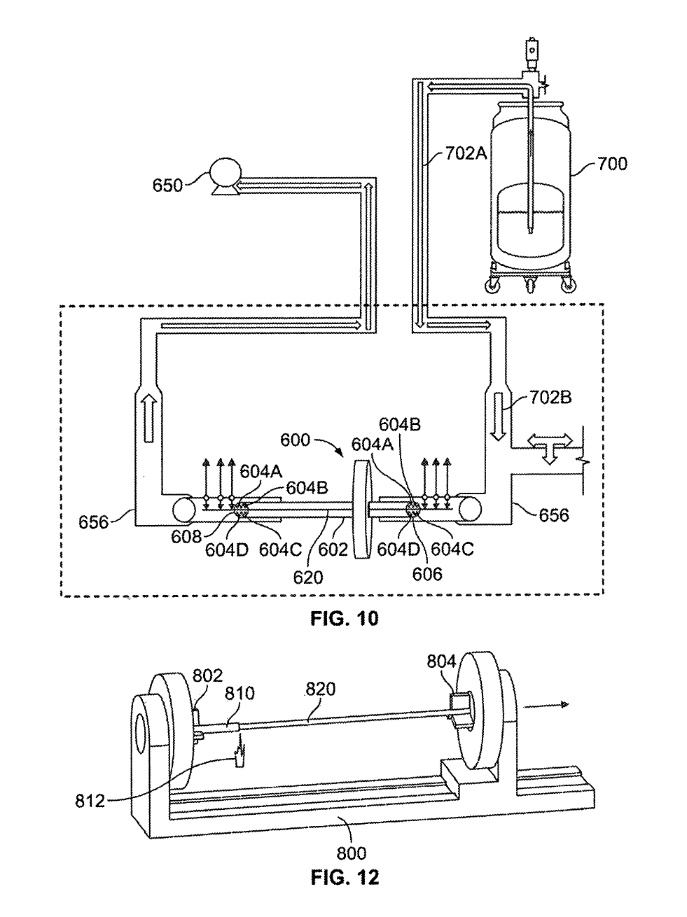

FIG. 10 illustrates yet another embodiment of the superconducting fiber as well as a system that may be used for cryogenic cooling. As shown, a superconducting fiber 600 is provided that has an insulating cladding 602 and a plurality of annular voids, holes, pores and/or passageways 604A through 604D that extend axially from inlet end 606 to an outlet end 608 to permit the passage of a cooling fluid from the inlet end to the outlet end to cool core 620 which may be made of the materials disclosed herein. As is also shown, the voids, pores and/or passageways have a substantially similar cross-section and are diposed throughout the cladding.

In operation, a cooling medium such as a liquid, gas, or combination thereof is used. In a preferred embodiment, liquid helium and/or liquid nitrogen is used and delivered into the passageways of the fiber by creating pressure differential between the inlet and outlet ends of the fiber which may be accomplished by a vacuum pump 650 or by other means known to those of skill in the art.

The outside diameter of fiber 600 was sealed by an intermediate plastic tube 656 that connects the fiber to a liquid helium Dewar 700 that was opened to allow the gaseous liquid helium 702A and then liquid helium 702B to flow into the tubing 656 and through fiber 600.

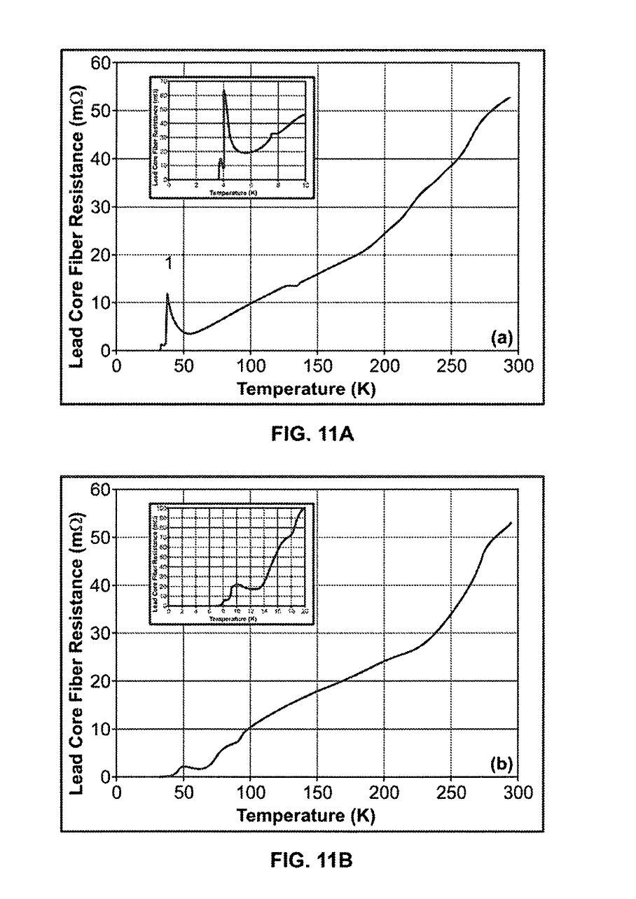

The voltage drop, current, and temperature measurements at both ends of the fiber were continuously monitored during use. The resistance versus temperature plot in FIG. 11 shows the superconducting transition of the lead core fiber via cryogenic cooling by infiltrating the holes, voids, pores and/or passageways in the cladding with liquid helium. The first plot shows the performance of the fiber upon cooling, while the second plot shows the performance upon warming to room temperature. The label “1” denotes a time just prior to maximum helium flow into the holes, voids, pores and/or passageways. Although, demonstrated with a lead core and liquid helium, the present invention may be utilized with any superconducting material, any pattern of cladding holes, voids, pores and/or passageways and any medium that will achieve temperatures required for superconductivity.

The superconducting fibers of the present invention may be fabricated by one of many traditional optical fiber manufacturing techniques and with equipment such as with a fiber draw tower or glass working lathe. The fabrication technique described below, and illustrated in FIG. 12, is one of many process techniques that can be used by one skilled in the art.

As shown in FIG. 12, in a preferred embodiment, the superconducting fibers of the present invention may be prepared by the melt-draw technique on a conventional glass-working lathe 800. The fiber drawing system includes chucks 802 and 804, which are used to clamp preform 810 and can spin together or separately at precisely controlled speeds. Chuck 804 can also be moved linearly to draw preform 810 when heated and softened by a hydrogen-oxygen torch 812 to over 1600° C. The superconducting material 820 such as yttrium barium copper oxide (1-2-3), 99.5% (metals basis) and bismuth strontium calcium copper oxide, (2-2-1-2), 99.9% (metals basis), Pb (99.9%) can be used as the source materials.

More specifically, a lead core superconducting fiber may be made using a glass working lathe (Litton Lathe Model HSJ143) that consists of traversing hand torch and tailstock chuck, as well as a headstock chuck for holding the preform. The ends of the preform are held in the rotating chucks, and heated to the softening point via the hydrogen/oxygen torch. The preform is then pulled into a fiber by rapidly traversing the tailstock downstream. The approximate maximum fiber length of 120 cm is limited by working distance between the chuck faces.

In yet another embodiment that may be used to create a superconducting fiber, a fused silica substrate tube (GE214, OD=8 mm, ID=3 mm) was fused to a core processing tube (GE214, OD=12.75 mm, ID=10.5 mm). The chosen superconducting powders were then placed in the processing tube and melted via an oxy-hydrogen flame to the appropriate melting temperature. A smaller diameter fused silica rod (GE 214, 8 mm) was used to push the lead melt into the substrate tube forming a preform with a lead core. Finally, the preform was drawn into a fiber via the Taylor process.

Using the the above described methods to create a yttrium barium copper oxide core 111, the drawing temperature required for was on the order of 2000-2100° C., which is much higher than the melting point of YBCO (˜1010° C.). As shown in FIG. 2, the rapid consolidation of the core melt upon fiberization produced a YBCO core with minimal or no porosity. However, the as-drawn YBCO core fibers were essentially nonsuperconducting due high-temperature phase separation, loss of oxygen upon relatively rapid cooling, possible silicon diffusion from the cladding, and thermal decomposition. Thus, the as-drawn fiber was annealed in an oxygen rich environment to recover it to a superconductive state. Generally, the YBCO core fibers were heated to 950° C., at a rate of 5° C./min, and held at this temperature for a period of for 12 hours, cooled to 500° C. at a rate of 1° C./min and held for 1.2 hours, and, then allowed to naturally cool to room temperature.

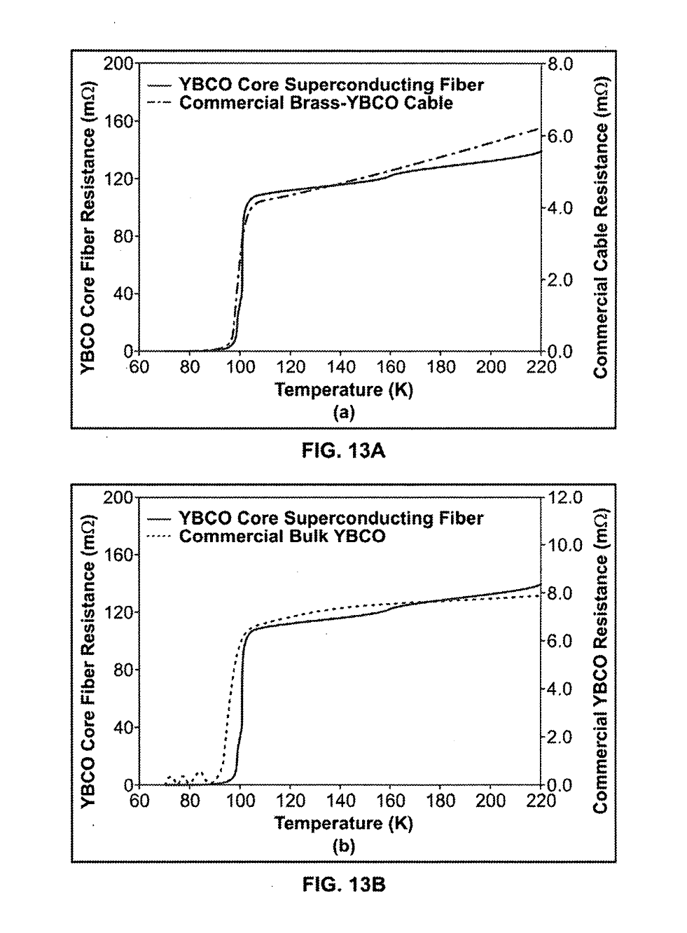

As seen in FIG. 13(a), the resistance of the commercial superconducting wire disappeared at temperatures on the order of 93 K. Although, the initial electrical resistance was considerably larger, the superconducting YBCO core fibers appeared to demonstrate a slightly higher T_{c} of approximately 95 K. As shown in FIG. 13(b), the superconducting transition was also evaluated for a commercially bulk YBCO disk (diameter≈25 mm, thickness≈3.1 mm) to further confirm the performance of the superconducting fiber. The transition temperature of the bulk YBCO, T_{c}≈93 K, was lower than both the commercial wire and superconducting fiber.

Superconductor fibers having cooling passageways and superconducting cores may be fabricated using a similar process but included several fused silica tubes displaced around a superconducting core fused silica tube containing the superconducting material. First, a fused silica handle tube (GE214, OD=6 mm, ID=3 mm) was fused to the core processing tube (GE214, OD=12.75 mm, ID=10.5 mm). The superconducting powder was then placed in the handle tube. The tube was then inserted and centered in an overclad tube (GE214, OD=12.75 mm, ID=10.5 mm). Smaller fused silica tubes (GE214, OD=3 mm, ID=1 mm), were then displaced around the core tube in the annulus between the overclad tube. A section of the preform was then heated to approximate 2200° C. to allow the overclad tube to collapse on the small tubes. As the superconducting powder melted, this structure was drawn into a fiber.

A two stage process may also be used in which the superconducting powder may be melted independently and allowed to flow into the drawn structure upon fiberization. This approach lends itself to direct implementation into standard draw tower production.

In one application, the superconducting fibers of the present invention provide a core having a superconducting material surrounded by vacant holes, voids, pores and/or passageways in an insulating material to allow for efficient cooling and electrical transport. The ordered hole fibers offer an efficient approach to cooling with liquid nitrogen or helium and the fused silica cladding provides thermal insulation.

The fibers of the present invention also have optical properties, waveguiding properties and uses in superconducting electronics. The fibers may be used as ultrasensitive, ultra-fast and ultralow noise light detectors as well as other sensors.

The fibers of the present invention allow for the use and implementation of several supporting methodologies. For example, the fibers may be spliced together to form an electrical transport system. This may be accomplished by connecting the inlet end of one fiber to the outlet end of another fiber and in other ways known to those of skill in the art. In addition, the fiber of the present invention may be used in other well known cable designs as well.

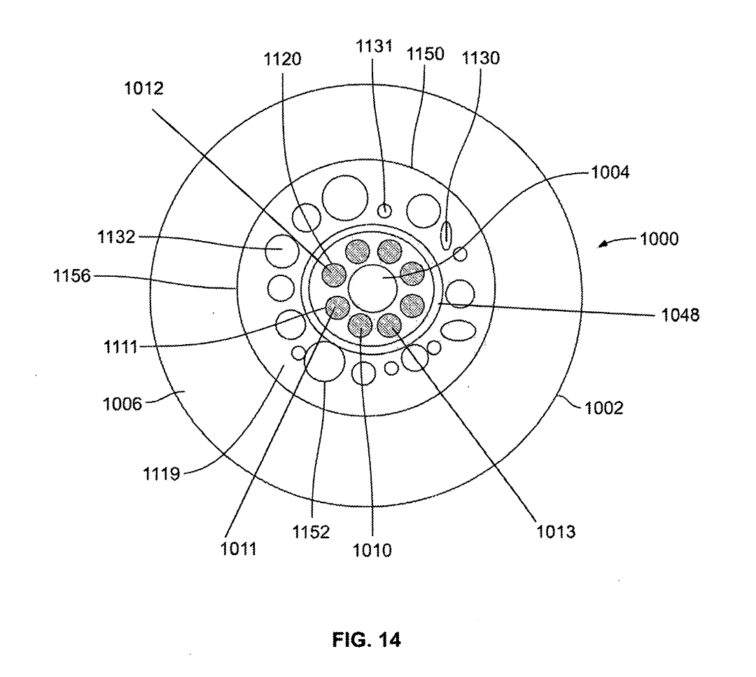

As shown in FIG. 14, another embodiment of the present invention provides a superconducting fiber 1000 having a cladding 1002, superconducting core 1004, a voidless region 1006, passageways 1010 through 1013, and voids, holes or pores 1130 through 1132. As is also shown, a metallic layer or coating is also provided that acts as an insulator to reflect thermal radiation.

For example, insulating layers 1111 and 1120 may be formed around one or more passageways as shown such as passageways 1011 and 1012. A reflective or insulating material or coating 1048 may also be disposed around all of the passageways. Instead of a metal coating, a glass layer may be used as well.

In addition, one or more of the voids may be coated as well as shown by layers or coatings 1152. Also, a reflective or insulating material or coating 1156 may be disposed around all of voids and passageways.

In another embodiment, the present invention provides a fiber structure with a cladding material and core composed of materials that exhibit superconducting properties. The cladding may be a glassy material, such as, but not limited to silica, fluorosilicate, germanosilicate, and borosilicate. The core may have a diameter <100 microns or >100 microns. The cladding is preferably <250 microns but may also be >250 microns. The cladding may also be coated with, but not limited, to a polyimide, acrylate, silicone, PEEK, carbon or other coatings applied to optical fibers or wires. Other coatings that may be used include silicone. In addition, metallic layers on the surface of the holes and/or in the cladding, and/or as the outer coating may he provided.

In yet other embodiments of the present invention, the voids in the cladding material may be filled with materials that also exhibit superconducting properties. This may be accomplished by sol gel processing or melt processing.

The superconducitng material used with the present invention may be a single crystal or polycrystalline as well as being piezoelectric. The superconducting materials that may be used with the present invention include, but are not limited to, pure elements, such as lead or mercury. In addition, the superconductors may be made of pure elements that are Type I or Type II. The core may also be made of bismuth strontium calcium copper oxide.

More specifically, the superconducting material may be alloys, such as Niobium-titanium (NbTi). Ceramics may also be used including the YBCO family such as yttrium-barium-copper oxides, and especially YBa2Cu3O7. Alloys such as Magnesium diboride (MgB2) may also be used. Other materials that may be used to form the superconducting core include lanthanum (La), tantalum (Ta), mercury (Hg), tin (Sn), indium (In), palladium (Pd), chromium (Cr), thallium (Tl), rhenium (Re), protactinium (Pa), thorium (Th), aluminum (Al), gallium (Ga), molybdenum (Mo), zinc (Zn), osmium (Os), zirconium (Zr), americium (Am), cadmium (Cd) ruthenium (Ru), titanium (Ti), uranium (U), hafnium (Hf), iridium (Ir), beryllium (Be), tungsten (W), platinum (Pt), lithium (Li) and rhodium (Rh). As stated above, the present invention results in little to no diffusion of the superconducting material into the surrounding cladding. In other embodiments, the present invention results in substantially no diffusion of the superconducting material into the cladding.

Additional applications of the present invention include use as structures or devices to sense environmental or biological parameters such as, but not limited to temperature, magnetic field strength, electrical field strength, and pressure. In addition, an optical fiber core or optical waveguide may be disposed in any portion of the fiber to enable sensing of environmental conditions to include, but are not limited to, temperature, strain, magnetic fields or electric fields.

In other embodiments that deploy an optical waveguide or optical fiber core that is disposed within the superconducting material, the refractive index varies in the portions of the fiber that surround the superconducting material and or the holes, voids, pores and/or passageways. In addition, a medium may be disposed within the holes, voids, pores and/or passageways that reduces or increases the energy or entropy of the system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

What is claimed is:

1. A superconducting fiber for transporting electricity comprising:
(a) a superconducting core; and
(b) a cladding surrounding said core.

2. The fiber of claim 1 wherein said core is yttrium barium copper oxide, bismuth strontium calcium copper oxide, niobium-titanium (NbTi), magnesium diboride (MgB2) lead (Pb), lanthanum (La), tantalum (Ta), mercury (Hg), tin (Sn), indium (In), palladium (Pd), chromium (Cr), thallium (Tl), rhenium (Re), protactinium (Pa), thorium (Th), aluminum (Al), gallium (Ga), molybdenum (Mo), zinc (Zn), osmium (Os), zirconium (Zr), americium (Am), cadmium (Cd) ruthenium (Ru), titanium (Ti), uranium (U), hafnium (Hf), iridium (Ir), beryllium (Be), tungsten (W), platinum (Pt), lithium (Li) and rhodium (Rh) with substantially no diffusion of the superconducting material of said core into said cladding.

3. The fiber of claim 1 further including a plurality of passageways in said cladding, said passageways arranged to permit the passage of a cooling fluid to cool said core.

4. The fiber of claim 3 wherein said passageways are a spaced distance from said core.

5. The fiber of claim 3 wherein said passageways are uniform in cross-section.

6. The fiber of claim 3 wherein said passageways have different cross-sections.

7. The fiber of claim 1 wherein said cladding is fused silica and said fiber has a diameter less than 250 microns.

8. The fiber of claim 3 wherein said passageways axially extend along said core from the inlet end to the outlet end.

9. The fiber of claim 3 wherein said cladding material includes voids which insulate said passageways.

10. An electrical transport system comprising:
(a) a plurality of superconducting fibers, each said fiber comprising an inlet and outlet end, a superconducting core, and a cladding surrounding said core; and
(b) said inlet end of a fiber adapted to connect to an outlet end of another fiber to splice said fibers together.

11. The fiber of claim 10 wherein said core is yttrium barium copper oxide.

12. The fiber of claim 10 further including a plurality of passageways in said cladding, said passageways arranged to permit the passage of a cooling fluid to cool said core.

13. The fiber of claim 12 wherein said passageways are a spaced distance from said core and a metal coating surrounds one or more of the passageways.

14. The fiber of claim 12 wherein said passageways are uniform in cross-section.

15. The fiber of claim 12 wherein said passageways have different cross-sections.

16. The fiber of claim 10 wherein said cladding is fused silica and said fiber has a diameter less than 1,000 microns.

17. The fiber of claim 12 wherein said passageways axially extend along said core from the inlet end to the outlet end.

18. The fiber of claim 12 wherein said cladding material includes voids which insulate said passageways and a metal coating surrounds one or more of said voids.

19. A superconducting fiber for transporting electricity comprising:
(a) a superconducting core; and
(b) a plurality of passageways, said passageways arranged to permit the passage of a cooling fluid to cool said core.

20. The fiber of claim 1 wherein said superconducting core operates at a temperature equal to or greater than 73 Kelvin.
